(19) United States
(12) Patent Application Publication
(10) Pub. No.: US 2016/0319690 A1
(43) Pub. Date: Nov. 3, 2016

(54) ADDITIVE MANUFACTURING METHODS FOR TURBINE SHROUD SEAL STRUCTURES

(71) Applicant: General Electric Company, Schenectady, NY (US)

(72) Inventors: Dechao Lin, Greer, SC (US); Srikanth Chandrudu Kottilingam, Simpsonville, SC (US); Yan Cui, Greer, SC (US); David Edward Schick, Greenville, SC (US); Steven John Barnell, Pelzer, SC (US)

(73) Assignee: General Electric Company

(21) Appl. No.: 14/700,534

(22) Filed: Apr. 30, 2015

(51) Int. Cl. F01D 11/12; B22F 3/11; B28B 1/00; B22F 5/00; B29C 67/00; B22F 3/105

(52) U.S. Cl. CPC F01D 11/122; B29C 67/0077; B22F 3/1055; B28B 1/001; B22F 5/009; B22F 3/1115; F01D 11/127; B33Y 80/00

(57) ABSTRACT

Additive manufacturing methods include iteratively fusing together a plurality of layers of additive material to build a turbine component comprising an intermediate portion that extends from a first surface to a second surface, wherein a cross section of at least portion of the intermediate portion of the turbine component comprises a plurality of walls disposed in a cellular configuration.

### BACKGROUND OF THE INVENTION

The subject matter disclosed herein relates to additive manufacturing and, more specifically, to additive manufacturing methods for turbine components such as turbine shroud seal structures and turbomachines comprising the same.

Turbomachines can include a compressor operationally linked to a turbine. Turbomachines can also include a combustor that receives fuel and air which is mixed and ignited to form hot gases. The hot gases are then directed into the turbine toward turbine blades. Thermal energy from the hot gases imparts a rotational force to the turbine blades creating mechanical energy. The turbine blades include end portions that rotate in close proximity to a stator. The closer the tip portions of the turbine blades are to the stator, the lower the energy loss. That is, reducing the amount of hot gases that pass between the tip portions of the turbine blades and the stator may lead to a larger portion of the thermal energy converted to mechanical energy. For example, where clearance between the tip portions and the interior surface of the turbine casing is relatively high, high energy fluid flow may escape without generating power during turbine operation. The escaping fluid flow constitutes tip clearance loss and is a major source of losses in the turbine. Turbine components may assist in limiting the amount of said clearance. Thus, depending on the specific application of the turbine component, one or more manufacturing considerations may be adjusted.

Additive manufacturing processes, for example, may generally involve the buildup of one or more materials to make a net or near net shape object, in contrast to subtractive manufacturing methods. Though “additive manufacturing” is an industry standard term (ASTM F2792), additive manufacturing encompasses various manufacturing and prototyping techniques known under a variety of names, including freeform fabrication, 3D printing, rapid prototyping/tooling, etc. Additive manufacturing techniques are capable of fabricating complex components from a wide variety of materials. Generally, a freestanding object can be fabricated from a computer aided design (CAD) model. One exemplary additive manufacturing process uses an energy beam, for example, an electron beam or electromagnetic radiation such as a laser beam, to fuse (e.g., sinter or melt) a powder material, creating a solid three-dimensional object in which particles of the powder material are bonded together. Different material systems, for example, engineering plastics, thermoplastic elastomers, metals, and ceramics may be used. Laser sintering or melting is one exemplary additive manufacturing process for rapid fabrication of functional prototypes and tools. Applications can include patterns for investment casting, metal molds for injection molding and die casting, molds and cores for sand casting, and relatively complex components themselves. Fabrication of prototype objects to facilitate communication and testing of concepts during the design cycle are other potential uses of additive manufacturing processes. Likewise, components comprising more complex designs, such as those with internal passages that are less susceptible to other manufacturing techniques including casting or forging, may be fabricated using additive manufacturing methods.

Laser sintering can refer to producing three-dimensional (3D) objects by using a laser beam to sinter or melt a fine powder. Specifically, sintering can entail agglomerating particles of a powder at a temperature below the melting point of the powder material, whereas melting can entail fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate, and the effects of processing parameters on the microstructural evolution during the layer manufacturing process can lead to a variety of production considerations. For example, this method of fabrication may be accompanied by multiple modes of heat, mass and momentum transfer, and chemical reactions.

Laser sintering/melting techniques can specifically entail projecting a laser beam onto a controlled amount of powder material (e.g., a powder metal material) on a substrate (e.g., build plate) so as to form a layer of fused particles or molten material thereon. By moving the laser beam relative to the substrate along a predetermined path, often referred to as a scan pattern, the layer can be defined in two dimensions on the substrate (e.g., the “x” and “y” directions), the height or thickness of the layer (e.g., the “z” direction) being determined in part by the laser beam and powder material parameters. Scan patterns can comprise parallel scan lines, also referred to as scan vectors or hatch lines, and the distance between two adjacent scan lines may be referred to as hatch spacing, which may be less than the diameter of the laser beam or melt pool so as to achieve sufficient overlap to ensure complete sintering or melting of the powder material. Repeating the movement of the laser along all or part of a scan pattern may facilitate further layers of material to be deposited and then sintered or melted, thereby fabricating a three-dimensional object.

For example, laser sintering and melting techniques can include using continuous wave (CW) lasers, such as Nd: YAG lasers operating at or about 1064 nm. Such embodiments may facilitate relatively high material deposition rates particularly suited for repair applications or where a subsequent machining operation is acceptable in order to achieve a finished object. Other laser sintering and melting techniques may alternatively or additionally be utilized such as, for example, pulsed lasers, different types of lasers, different power/wavelength parameters, different powder materials or various scan patterns to facilitate the production of one or more three-dimensional objects.

Accordingly, additive manufacturing methods for turbine components and turbomachines comprising the same would be welcome in the art.

### BRIEF DESCRIPTION OF THE INVENTION

In one embodiment, an additive manufacturing method is disclosed. The additive manufacturing method comprises iteratively fusing together a plurality of layers of additive material to build a turbine component comprising an intermediate portion that extends from a first surface to a second surface. Moreover, a cross section of at least portion of the intermediate portion of the turbine component comprises a plurality of walls disposed in a cellular configuration.

In another embodiment, a turbine component is disclosed. The turbine component comprises an intermediate portion that extends from a first surface to a second surface comprising a plurality of layers of additive material fused together. Moreover, a cross section of at least portion of the intermediate portion of the turbine component comprises a plurality of walls disposed in a cellular configuration.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a partial schematic view of a turbomachine including a turbine component according to one or more embodiments shown or described herein;

FIG. 2 is a partial schematic view of a turbine portion of the turbomachine of FIG. 1 according to one or more embodiments shown or described herein;

FIG. 3 is a cross-sectional view of the turbine component arranged in the turbine portion of the turbomachine according to one or more embodiments shown or described herein;

FIG. 4 is a cross-sectional view of the turbine component prior to formation of a deformation zone according to one or more embodiments shown or described herein;

FIG. 5 is a cross-sectional view of the intermediate portion of the turbine component according to one or more embodiments shown or described herein; and,

FIG. 6 illustrates an additive manufacturing method according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

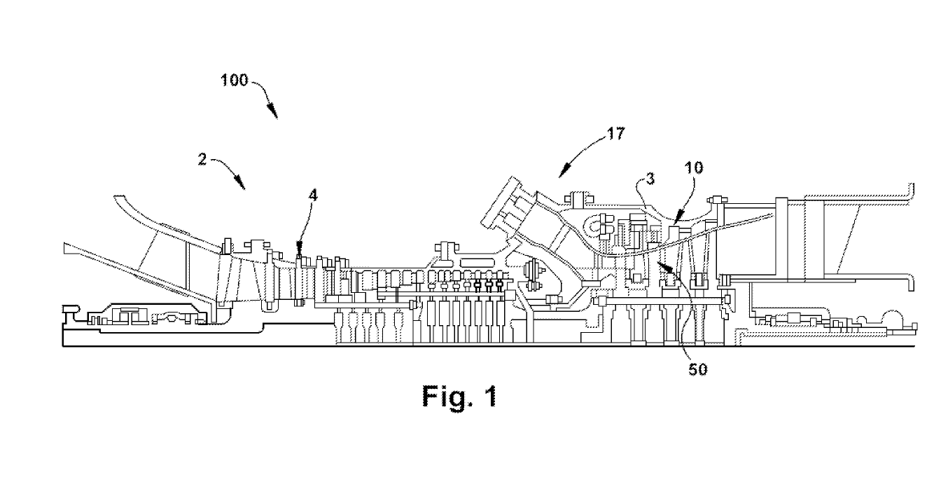

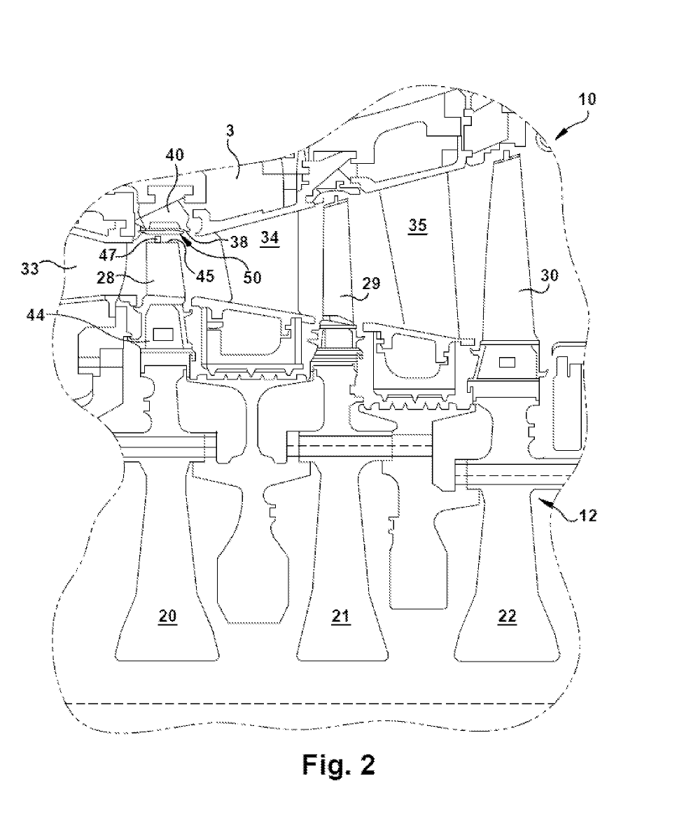

With reference to FIGS. 1 and 2, a turbomachine constructed in accordance with an exemplary embodiment is indicated generally at 2. Turbomachine 2 includes a housing 3 within which is arranged a compressor 4. Compressor 4 is linked to a turbine 10 through a common compressor/turbine shaft or rotor 12. Compressor 4 is also linked to turbine 10 through a plurality of circumferentially spaced combustors, one of which is indicated at 17. In the exemplary embodiment shown, turbine 10 includes first, second and third stage rotary members or wheels 20-22 having an associated plurality of blade members or buckets 28-30. Wheels 20-22 and buckets 28-30 in conjunction with corresponding stator vanes 33-35 define various stages of turbine 10. With this arrangement, buckets 28-30 rotate in close proximity to an inner surface 38 of housing 3.

In the exemplary embodiment shown, a plurality of shroud members, one of which is indicated at 40 is mounted to inner surface 38. As will be discussed more fully below, shroud member 40 defines a flow path for high pressure gases flowing over buckets 28-30. At this point, it should be understood that each bucket 28-30 is similarly formed such that a detailed description will follow with respect to bucket 28 with an understanding that the remaining buckets 29 and 30 include corresponding structure. As shown, bucket 28 includes a first or base portion 44 that extends to a second or tip portion 45 having a projection 47. Hot gases flowing from combustor 17 pass across tip portion 45 of buckets 28-30 along inner surface 38. In order to ensure proper flow, a turbine component 50 such as a turbine shroud seal structure can be mounted to shroud member 40 adjacent tip portion 45 of bucket 28. Of course, it should be understood that additional turbine components (not separately labeled) are mounted adjacent to the remaining buckets 29 and 30.

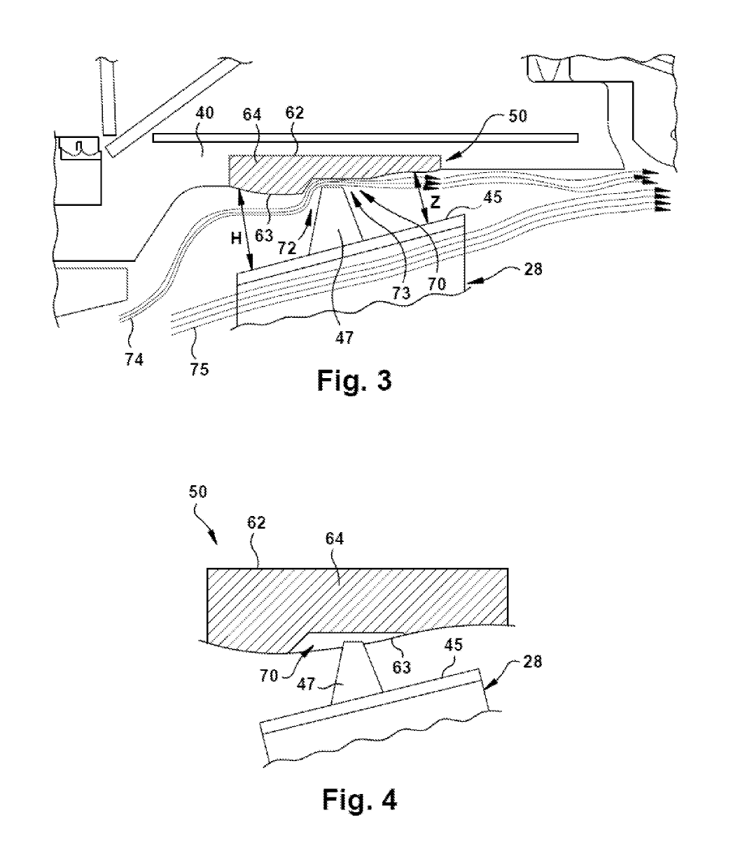

The turbine component 50 disclosed herein can comprise a variety of different turbine components that may need to comprise a cellular configuration cross section such as including, but not limited to, turbine shroud seal structures (as illustrated in FIGS. 2-5) and near flow path seals. As best shown in FIG. 3, turbine component 50 comprises an intermediate portion 64 that extends from a first surface 62 to a second surface 63. In some embodiments, such as that illustrated, the second surface 63 may comprise a contoured surface. For example, within this arrangement, operation of turbine 10 can cause projection 47 on each of the buckets 28 to form a deformation zone or groove 70 across turbine component 50 such as illustrated in FIG. 4.

In some exemplary embodiments, such as that illustrated in FIGS. 3 and 4, deformation zone 70 can include an inlet zone 72 and an outlet zone 73. Inlet zone 72 receives a tip leakage airflow 74 from an upstream end of turbine 10 while the outlet zone is configured to pass the airflow towards a downstream end of turbine 10, e.g., towards the second and third stages. Inlet zone 72 can be spaced a first distance H from tip portion 45 of bucket 28, while outlet zone 73 can be spaced a second distance Z from tip portion 45 of bucket 28. In some embodiments, second distance Z may be substantially equal to or less than first distance H such that the tip leakage airflow 74 passing across tip portion 45 exiting outlet zone 73 may be streamlined. By streamlining tip leakage airflow 74, interactions between a main airflow 75 and tip leakage airflow 74 may be reduced.

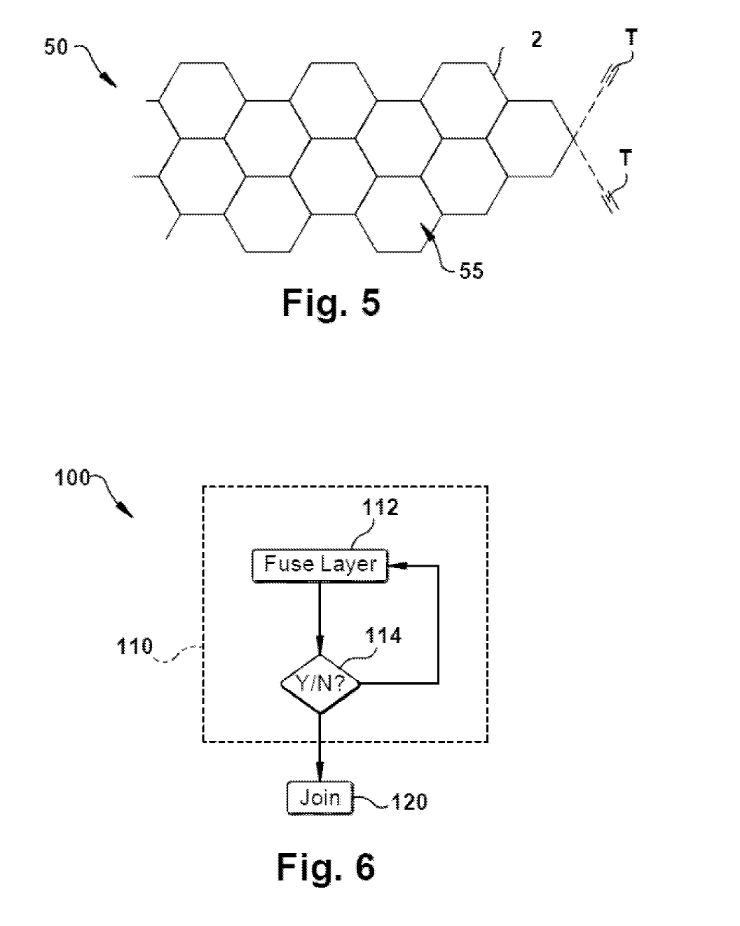

The turbine component 50 may, for example, thereby comprise a turbine shroud seal structure as illustrated comprising a plurality of configurations to reduce or limit airflow between the projection 47 of the bucket 28 and the shroud member 40. For example, as illustrated in FIG. 5, in some embodiments the turbine component 50 may comprise a cross section comprising a plurality of walls 52 disposed in a cellular configuration wherein the plurality of walls 52 form a plurality of cells 55. The cellular configuration cross section may be configured at the first surface 62, the second surface 63 or anywhere throughout the intermediate portion 64 of the turbine component 50. For example, in some embodiments, the cross section comprising the plurality of walls 52 disposed in the cellular configuration may extend through the entire intermediate portion 64 from the first surface 62 to the second surface 63. In some embodiments, the cross section comprising the plurality of walls 52 disposed in the cellular configuration may extend for only a portion of the intermediate portion 64 such as starting from the second surface 63 and discontinuing before reaching the first surface 62. In such embodiments, the first surface 62 (and potentially a remaining portion of the intermediate portion 64) may not comprise the plurality of walls 52 disposed in the cellular configuration, but can alternatively comprise a different configuration such as a solid piece of material or a different plurality of walls 52. The cellular configuration may assist in reducing wear of the projection 47 from the tip portion 45 of the bucket 28 by reducing the amount of material of the turbine component 50 that the projection 47 carves away.

In some embodiments, each of the plurality of walls 52 disposed in a cellular configuration (i.e., forming a plurality of cells 55) may comprise a substantially uniform thickness T. The uniform thickness T for each of the plurality of walls 52 may assist in preventing or limiting uneven wear on the projection 47 from the tip portion 45 of the bucket 28.

In some embodiments, the cellular configuration may comprise a substantially honeycomb configuration such as illustrated in FIG. 5. In such embodiments, for example, each of the plurality of cells 55 may comprise six substantially uniform walls 52 in a hexagon configuration such that the plurality of cells 55 combine to form a substantially honeycomb configuration. In even some of these embodiments, each of the plurality of walls 52 for each of the plurality of cells 55 in the honeycomb configuration may comprise a substantially uniform thickness T.

Referring now to FIG. 6, an additive manufacturing method 100 is illustrated for manufacturing turbine components 50 as disclosed herein. The additive manufacturing method 100 generally comprises iteratively fusing together a plurality of layers of additive material to build the turbine component 50 in step 110. In some embodiments, the first surface 62 of the turbine component 50 may be built directly on to shroud member 40. In other embodiments, the additive manufacturing method 100 may further comprise joining the turbine component 50 built in step 110 to the shroud member 40 in step 120.

Specifically, the additive manufacturing method 100 first comprises iteratively fusing together a plurality of layers of additive material in step 110 to build the turbine component 50. As used herein, “iteratively fusing together a plurality of layers of additive material” and “additive manufacturing” refers to any process which results in a three-dimensional object and includes a step of sequentially forming the shape of the object one layer at a time. For example, as illustrated in FIG. 6, iteratively fusing together a plurality of layers of additive material in step 110 can comprise the individual steps of fusing together an individual layer of additive material in step 112 and determining whether another layer is required in step 114. If the turbine component 50 requires another layer, than the additive manufacturing method 100 repeats step 112. If the turbine component 50 does not require another layer, than the additive manufacturing method 100 can conclude or optionally advance to a joining process in step 120.

Additive manufacturing processes include, but are not limited to, powder bed additive manufacturing and powder fed additive manufacturing processes such as by using lasers or electron beams for iteratively fusing together the powder material. Additive manufacturing processes can include, for example, three dimensional printing, laser engineering net shaping (LENS), direct metal laser sintering (DMLS), direct metal laser melting (DMLM), selective laser sintering (SLS), plasma transferred arc, freeform fabrication (FFF), and the like. One exemplary type of additive manufacturing process uses a laser beam to fuse (e.g., sinter or melt) a powder material (e.g., using a powder bed process). Additive manufacturing processes can employ powder materials or wire as a raw material. Moreover additive manufacturing processes can generally relate to a rapid way to manufacture an object (article, component, part, product, etc.) where a plurality of thin unit layers are sequentially formed to produce the object. For example, layers of a powder material may be provided (e.g., laid down) and irradiated with an energy beam (e.g., laser beam) so that the particles of the powder material within each layer are sequentially fused (e.g., sintered or melted) to solidify the layer.

The additive material fused together can comprise a variety of different potential materials that can depend on, for example, the type of additive manufacturing method and/or the specific application for the turbine component 50. For example, the additive material can comprise any material that may be fused (e.g., sintered) by a laser beam or other energy source. In some embodiments, the additive material can comprise a powder metal. Such powder metals can include, by non-limiting example, cobalt-chrome alloys, aluminum and its alloys, titanium and its alloys, nickel and its alloys, stainless steels, tantalum, niobium or combinations thereof In other embodiments, the additive material may comprise a powder ceramic or a powder plastic. In some embodiments, the additive material may comprise an abradable material that can be cut away by the projection 47 from the tip portion 45 of the bucket 28 as should be appreciated by those skilled in the art.

The additive manufacturing method 100 can thereby build the turbine component 50 comprising an intermediate portion 64 that extends from a first surface 62 to a second surface 64. Specifically, the additive manufacturing method 100 can build the turbine component 50 such that at least a portion of the intermediate portion 64 comprises a cross section comprising a plurality of walls 52 disposed in a cellular configuration as discussed above. By using an iterative additive manufacturing process, each of the plurality of walls 52 may comprise a substantially uniform thickness T, whereas other manufacturing methods may lead to some walls 52 having different thicknesses T than other walls 52. Moreover, by controlling the build of the turbine component 50 in a layer-by-layer process, the cross section comprising the plurality of walls 52 may be uniform throughout the entire intermediate portion 64, or may comprise one or more variations therein.

In some embodiments, the turbine component 50 (e.g., a turbine shroud seal structure) may be built via the additive manufacturing method 100 directly on the shroud member 40. The shroud member 40 may be integral with or otherwise connected to the inner surface of the housing 3 of the turbomachine 2 that is adjacent the rotary member 20. In such embodiments, the additive manufacturing method 100 may thereby end after the turbine component 50 is built in step 110. In even some embodiments, the turbine component 50 may be built via the additive manufacturing method 100 directly on any other type of suitable turbine component such as a blade, bucket, or the like.

However, in other embodiments, the additive manufacturing method 100 can further comprise joining turbine component 50 to the shroud member 40 if it is built in step 110 independent of the shroud member 40. In such embodiments, the turbine component 50 may be joined with the shroud member 40 in step 120 in any operable method such as, but not limited to, brazing, welding or the like. For example, heat may be applied in to join the materials (such as with supplemental braze, weld or flux materials) for any suitable temperature via any suitable heat sources, iterations, ramp rates, hold times, cycles and the like.

It should now be appreciated that turbine components may be built via iteratively fusing together a plurality of layers of additive material. Such turbine components can comprise a cross section having a plurality of walls disposed in a cellular configuration. Moreover, in even some embodiments, via the additive manufacturing process, the plurality of walls may each comprise a substantially uniform thickness.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An additive manufacturing method comprising:
iteratively fusing together a plurality of layers of additive material to build a turbine component comprising an intermediate portion that extends from a first surface to a second surface;
wherein a cross section of at least portion of the intermediate portion of the turbine component comprises a plurality of walls disposed in a cellular configuration.

2. The additive manufacturing method of claim 1, wherein each of the plurality of walls comprises a substantially uniform thickness.

3. The additive manufacturing method of claim 1, wherein the cellular configuration comprises a substantially honeycomb configuration.

4. The additive manufacturing method of claim 3, wherein each of the plurality of walls comprises a substantially uniform thickness.

5. The additive manufacturing method of claim 1, wherein the cross section comprising the plurality of walls disposed in the cellular configuration extends through the entire intermediate portion from the first surface to the second surface.

6. The additive manufacturing method of claim 1, wherein the cross section comprising the plurality of walls disposed in the cellular configuration extends for only a portion of the intermediate portion.

7. The additive manufacturing method of claim 1, wherein the turbine component is built on a surface of a shroud member.

8. The additive manufacturing method of claim 1, further comprising joining the turbine component to a surface of a shroud.

9. The additive manufacturing method of claim 1, wherein the additive material comprises an abradable material.

10. The additive manufacturing method of claim 1, wherein the turbine component comprises a turbine shroud seal structure.

11. A turbine component comprising:
an intermediate portion that extends from a first surface to a second surface comprising a plurality of layers of additive material fused together;
wherein a cross section of at least portion of the intermediate portion of the turbine component comprises a plurality of walls disposed in a cellular configuration.

12. The turbine component of claim 11, wherein each of the plurality of walls comprises a substantially uniform thickness.

13. The turbine component of claim 11, wherein the cellular configuration comprises a substantially honeycomb configuration.

14. The turbine component of claim 13, wherein each of the plurality of walls comprises a substantially uniform thickness.

15. The turbine component of claim 11, wherein the cross section comprising the plurality of walls disposed in the cellular configuration extends through the entire intermediate portion from the first surface to the second surface.

16. The turbine component of claim 11, wherein the cross section comprising the plurality of walls disposed in the cellular configuration extends for only a portion of the intermediate portion.

17. The turbine component of claim 11, wherein the turbine component of claim 11 comprises a turbine shroud seal structure and wherein the first surface of the turbine component is joined to a surface of a shroud.

18. The turbine component of claim 17, wherein the cross section comprising the plurality of walls disposed in the cellular configuration extends from the second surface and only for a portion of the intermediate portion.

19. The turbine component of claim 11, wherein the additive material comprises an abradable material.

20. The turbine component of claim 11, wherein a first surface cross section is different than a second surface cross section.
